(19) United States
(12) Patent Application Publication
(10) Pub. No.: US 2014/0279978 A1
(43) Pub. Date: Sep. 18, 2014

(54) MASS CUSTOMIZATION OF MEDIA AND STATISTICAL PROJECTION FROM MASS CUSTOMIZED MEDIA

(71) Applicant: Featuring Me Holdings LLC, Nashville, TN (US)

(72) Inventors: Gregory Green, Nashville, TN (US); Felix Sedal, Templestowe (AU)

(21) Appl. No.: 14/082,613

(22) Filed: Nov. 18, 2013

Related U.S. Application Data
(63) Continuation of application No. PCT/US2012/055412, filed on Sep. 12, 2012.
(60) Provisional application No. 61/534,834, filed on Sep. 14, 2011.
(60) Provisional application No. 61/534,830, filed on Sep. 14, 2011.

(51) Int. Cl. G06F 17/30

(52) U.S. Cl. CPC G06F 17/30743
USPC 707/695

(57) ABSTRACT

Systems and methods for providing mass customized media items, such as songs or other audio items, are provided. Multiple versions of one or more song segments may be generated, as well as a version of a song using each of the segment versions. One or more generated versions of the song may be provided to a user. The song version or versions may be provided in response to a user selection of one or more of the segment versions.

### CROSS-REFERENCE TO RELATED APPLICATIONS

This application is a continuation of International Application No. PCT/US2012/055412, filed Sep. 19, 2012, which claims the benefit of, and priority to, U.S. Provisional Application No. 61/534,834, filed Sep. 14, 2011, and U.S. Provisional Application No. 61/534,830, filed Sep. 14, 2011, the disclosure of each of which is incorporated by reference in its entirety.

### BACKGROUND

Distribution of audio files, especially in the music industry, has become increasingly skewed towards distribution of material intended for mass consumption by consumers. This trend may be particularly pronounced for distribution of physical media, such as compact disc recordings. More recent digital media distribution systems provide audio, such as musical recordings, electronically, but such systems still are aimed at providing mass-consumption recordings. In general, musicians or other artists may create music that is relatively “generic,” so as to appeal to a large cross-section of consumers, or may limit themselves to specific niche audiences.

### BRIEF SUMMARY

The invention provides methods and systems for providing customized media items to users and for obtaining statistical data from such media, which may then be used for additional customization, media suggestion, consumer profiling, and other uses. Additional features, advantages, and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

According to an embodiment, a plurality of song versions may be created and made available to users. User preference data may be obtained for one or more versions. Based upon the preference data, additional media may be provided to one or more users. The preference data may include download, priority, distribution, purchasing, or other data. Additional media provided to users may include song suggestions, special editions, concerts, advertising, or other media.

### BRIEF DESCRIPTION OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows a schematic illustration of an example song having different versions of multiple segments.

FIG. 2 shows a schematic illustration of different versions of song segments selected by a user.

FIG. 3 shows an example computerized user interface for selecting a version of song segments and/or a song.

FIG. 4 shows an example process for generating a mass customized media item.

FIG. 5 shows a computer system suitable for use with the present disclosure.

FIG. 6 shows an example system suitable for use with the present disclosure.

FIG. 7 shows an example process for deriving information related to mass customized media items.

FIG. 8 shows an example user interface for obtaining, presenting, and/or analyzing preference data related to one or more mass customized media items.

### DETAILED DESCRIPTION

In a conventional system music recordings may be created by an artist that has signed a contract with a particular label. The label works with the label to create a music product, such as a track, an album, or other collection of music recordings. The recordings are then distributed to end consumers.

In many cases, music and other media consumption may be moving to pure online distribution and consumption. It has been found consequence of this movement may be an erosion of the price per track (PpT), because digital sales typically have lower margins for the industry as a whole. Digital downloads may have a marginal cost of essentially zero, with no added value—such as music notes, liner notes—and in some cases DRM limits the usage. Further, the online PpT may be artificially held at a particular price point, such as music stores which set the price for every track to be $0.99 or another predetermined value. It has been found that there is a need in the art for production, distribution, and/or revenue models that are equitable to the artist, the production and label companies, and that provide acceptable value to end consumers.

Even in conventional digital distribution contexts, it has been found that music distribution still uses the creation of a “song” or “track” product, which is recorded to some medium and then duplicated and provided to the customer in various forms and revenue models. For example, CDs are used in conventional retail contexts, whereas digital distribution may be used for instant access or broadcast, or where the revenue is captured based upon related advertising. Such systems typically rely on a static product with little or no effective anti-copying “protection,” and often no engagement with the consumers of the product. In some cases, new or special editions, such as “live recordings” may be produced. However, such special editions are still only slightly-modified version of the initial product, and are still delivered as-is, in a single version, to any purchasing customers. For example, special editions often provide higher-quality versions of existing songs, and the live versions often provide lower quality-versions of existing songs but with the addition of live spontaneity.

It has been found that there is a demand for different interpretations of existing songs or other media. The present disclosure presents techniques and systems suitable for recording, arranging, and distributing music that includes multiple options or versions of the recording from which a consumer may chose, recording and distribution of personalized recordings and/or limited edition physical media, and other features. Such customization may allow musicians or other artists to reach a broader audience and determine what tracks reach their intended audience most effectively. Consumers may benefit from the increased choice and customization in purchased media, thus providing a higher value. The techniques disclosed herein may be referred to as “mass customization” of audio or other media.

According to an example technique for mass customization of songs, a music artist may write, perform, and/or otherwise develop an initial song or other media item as usual. For example, an artist or group of artists may develop a song by writing music and lyrics that are to be recorded for later distribution to consumers. As used herein, an “artist” may refer to a single artist, such as a solo performer, or to a group of artists, such as a band or other collaborative group. An “artist” may be an audio, audio-visual, or any other suitable type of artist. In contrast to conventional techniques that would rely on the artist developing and recording a single version of the song, in a mass customization technique the artist may record multiple tracks using combinations of variables and breakpoints. For example, variables upon which the artist may develop different versions may include tone, beat, member highlighting, localization, or the like. Examples of variations in in tone may include happy, sad, aggressive, or similar variation. Examples of variations in beat may include upbeat, down-tempo, poppy, or the like. Examples of member highlight variations may include guitar-, drum-, vocal-heavy, or the like. Examples of variations in localization may include versions that use indigenous instruments, geographical tone, beat, or other sound, or the like.

In addition, various breakpoints may be defined based upon known general structures of songs, or upon structure specific to a single song. For example, breakpoints may be defined to delineate different segments, such as the introduction, chorus, refrain, bridge, solo, and/or coda within a song. The breakpoints may be determined by an artist, such as a band or a producer, and may be determined before any audio is recorded, such as during a pre-production stage. Multiple versions and takes may be recorded, and may be maintained in a computerized system. The artist or other associated entity, such as a label or distributor, may select versions to be released. In some cases, an original artist may have complete control over each possible iteration and version of the song. In other configurations, other entities may select various versions, segments, or variations that are made available to consumers. A mass customization process as described herein may yield a relatively high number of versions of a single song or other media item for a relatively small number of initial variations. For example, a song with X variables and Y breakpoints may yield up to X^{Y} final versions.

As an example, an artist may use a song that has 5 break points after each of the introduction, chorus, solo, refrain, and code. As another example, if the artist is a band, each band member may select a version for the following section. FIG. 1 shows an example schematic representation of the possible resulting versions of the song. For example, after the introduction, the guitarist (G), bassist (B), and drummer (D) may each select a version of the next section to be included in versions of the song. Similar selections may be made after the chorus, solo section, and so on. As another example, in the solo segment each member may select a version to showcase themselves, after which the refrain segment may include choices again selected by each member of the band. A similar selection process may be used in the case of any other collaborative group, or a solo artist.

As breakpoints and variables are added to the song, the number of possible variations increases rapidly. In the shown in FIG. 1, if three variables (G, B, D) and five breakpoints are used, 243 different variations of the song may be generated or possible.

When the song is complete in some or all desired versions, the versions may be distributed to customers. Distribution may be done digitally, using physical media, or any combination thereof In some configurations, a customer may be presented with a computer interface that allows the user to examine different versions of the song and/or segments of the song. For example, the user may be able to listen to segments and select a “path” through the possible versions of the song that suits the user's musical preference.

For example, following the example described with respect to FIG. 1, a consumer may prefer the guitarist's choice after the intro, then the bassist's choice for the chorus. The consumer may prefer the version of the song with the drum solo and the bassist's version of the refrain (e.g., to match the bassist's choice for the chorus). Finally, the consumer may prefer the guitarist's ending. The user's selected “path” through the song is shown schematically in FIG. 2.

When the path has been chosen the selected version of the song may be assembled and the user may be presented with the option of downloading a digital copy of the song, and/or of selecting more versions and/or songs. In a configuration, the system may create a tangible media with customized components, such as liner notes, graphics, and the like, which may match comments from the artist. For example, the artist may provide commentary indicating why they chose particular variables at the different breakpoints. In some cases, each possible version of the song may be stored at a system that allows users to select versions of the song segments and thereby create their preferred versions of the song. The system may present a user with the appearance that the selected song is being assembled in real-time or responsive to the user's selections, or it may show the user how he is navigating through different pre-generated versions of the song.

FIG. 3 shows an example computerized user interface for selecting a version of song segments and/or a song. The interface may include a song map 310 that shows selected and/or available segment versions for the song. As a user selects different versions of the segment, the map may display the selected path through the different versions of the song. The interface also may indicate an upcoming segment version 320 based upon segments selected by the user, and/or other available segment versions 330. A segment player 340 may allow the user to listen to the available segment versions for each selection point in the song map 310 to select a preferred version. The various interface elements illustrated in FIG. 3 are illustrative only, and other displays and interfaces may be used.

FIG. 4 shows an example process for generating a song according to a customization mass technique as disclosed herein. One or more versions of segments of a song may be generated. For example, an artist may generate one or more versions of each segment (intro, refrain, coda, etc.) of a song as previously described. One or more song versions may be generated based upon the segment versions. In some cases, each possible combination of segment versions may be generated. In other cases, only a subset of the possible song versions may be generated. Segment versions may be provided to a user, such as by allowing a user to listen to the segment versions as previously described. A selection of one or more segments may be received from the user, and a version of the song that includes the selected segments may be provided to the user. Other steps may be included, and various steps shown in FIG. 4 may be omitted without departing from the scope of the present disclosure.

Many record labels and artists are strongly “anti-piracy,” i.e., strongly discourage the unauthorized copying and/or sharing of their copyrighted musical works. Techniques and systems as disclosed herein may allow the use of the piracy networks, such as peer-to-peer and other systems commonly used to distribute unauthorized copies of media items, as marketing tools. For example, a version of a song may be released to showcase the different choices for the consumer. The released version may be one that is not musically sensical or viable, or for which there is not an expected high demand. The version may be intentionally made available for seemingly-unauthorized copying, such as by placing on a widely-used peer-to-peer or similar network. At the same time, potential customers or other users may be made aware that other versions of the song may be created. Thus, each song version essentially becomes a library or portfolio for the song and/or the artist. In some cases the individual price for song versions can be lowered to increase demand. Thus, customers may be able to obtain a customized or seemingly-customized version of the song for less than the customer would expect to pay for a non-customized song regularly. In some cases this model may benefit from “piracy,” thus becoming economically more viable that the previous models of music consumption that may be economically harmed by unauthorized copying.

In some configurations, only a subset of all possible variations of a song may be stored and/or made available to consumers. For example, the storage space required to store every possible version of the song with different numbers of segments and versions in the example described with respect to FIG. 1 is shown below. The values are shown for an example quality of PCM/8-channel (7.1), lossless or no compression, which results in a bandwidth of about 1.5 mb/s. As another specific example, audio may be stored in DTS-HD or other lossless codecs. It will be understood that these codecs, techniques, and values are illustrative only, and various other quality, compression, and or storage techniques may be used.

| Segment | Seconds | MB | Versions | MB |
|---|---|---|---|---|
| 1 | 30 | 45 | 1 | 45 |
| 2 | 60 | 90 | 3 | 270 |
| 3 | 60 | 90 | 9 | 810 |
| 4 | 60 | 90 | 27 | 2430 |
| 5 | 60 | 90 | 81 | 7290 |
| 6 | 30 | 45 | 243 | 10935 |
| | | | Total (MB) | 21780 |
| | | | Total (GB) | 21.78 |

As shown by the example values, the storage required for every version of an average song is within the capacity of current storage systems, though in some cases it may be desirable to store only a subset of all possible versions of a song. For example, it may be determined that a subset of the versions available would be unlikely to generate revenue sufficient to justify the resources needed to store and/or distribute those versions.

Embodiments of the disclosed subject matter provide consumers with the ability to more specifically define and select the music they receive, and to interact with artists in a more personalized way. As usage and download information from the different mixes of a song becomes available, data mining and analysis may be performed to determine the preferences based on various segmentations of users who access the songs. For example, data may be obtained based upon geographic, demographic, psychographic, ethnographic or other demographic groupings or measures of those users. The aggregate data may be used, for example, to create targeted market mixes, such as a particular song or album intended for a particular geographic, age-based, ethnic, or other grouping of customers. Continuing the example provided above, after multiple downloads of various versions of a song or songs, an artist may determine that a statistically significant number of a certain path are being downloaded from Atlanta. The artist may then release a special edition physical media of songs for that market. In some cases, the special edition songs or other media also may be made available for download electronically. Even if the digital versions are copied without authorization, the physical medium may maintain value, and/or may act as a further marketing tool.

Media customization and download data may be combined with other relevant data from other sources. For example, for ethnographic and/or psychographic metrics, a distribution portal may incentivize member users, such as via free song download credits, to develop their profile through various tests. The collected information may be used for further analysis in conjunction with customization and download data.

With the information gathered from downloads, purchases, user information, preferences and tests, multiple products may be tailored or customized to reach unique consumer segments. A consumer segment may be any group of consumers that shares one or more metrics as described above, and that has been identified as having a potential interest in a specific version of one or more media items, such as a song or collection of songs. For example, possible tour locations, product stocking, and marketing budgets may be determined based upon the expected interest of various customer segments based upon the metrics for that segment. As a specific example, it may be determined that customers within a particular geographic are less likely to purchase or download songs from a particular artist. In response, the marketing budget for that area may be increased. Similarly, the direction or tone of music selected by consumers within one or more segments may be used to determine a direction that the artist's future music should follow, the type and content of special editions or other works, whether to create or support related artists such as spinoff bands, what types of music or other performances related groups should perform, and the like. As another example, the types of music downloaded or otherwise apparently preferred by one or more customer segments may be used to determine other artists to suggest to customers within that segment, marketing channels to use for various artists, or other products to promote to that segment.

FIG. 7 shows an example process for deriving information related to mass customized media items. Initially, segment versions for one or more songs or other media items may be created as previously described. Song versions may be generated based upon the segment versions. The song versions may be provided to one or more users as previously described. Based upon user access or other data, user preference data for one or more of the versions may be received. Other additional media, such as song suggestions, special editions, concerts, advertising, or any other suitable digital or physical media may be provided to one of the users or to a new user based upon the received preference data.

FIG. 8 shows an example user interface for obtaining, presenting, and/or analyzing preference data related to one or more mass customized media items. The interface may show basic biographical or other information about an album, song, or other work, such as album or song cover art 805, artist and song name, issue date, and the like. An interface may calculate and provide various metrics regarding mass customized media items. For example, the number of downloads 820, which may include authorized or unauthorized downloads, and/or related revenue may be calculated and displayed. Information on the most-popular version of a song or any other particular version may be displayed 810. Information on relative popularity, preferences, downloads, or any other metric may be displayed. For example, versions that have not been downloaded or otherwise accessed 832, relative interest or distribution spreads 830, musical relationships between different versions 834, and/or various lists of the most popular or most downloaded versions by various customer segments 836 may be displayed. In general, any statistical information that may be determined for one or more versions of one or more songs may be calculated and displayed, either as raw data or graphically as illustrated.

Various embodiments may deviate from the illustrative structures described herein. For example, the components and modules described may be combined or further split functionally from the specific structures described. Each of the components may be implemented as a software module or a module that combines software and hardware, and multiple illustrated modules may be combined into a single physical or logical module. Generally, any number of functions may be embodied in any number of modules.

Embodiments of the presently disclosed subject matter may be implemented in and used with a variety of component and network architectures. FIG. 5 is an example computer 20 suitable for implementing the disclosed systems and methods. The computer 20 may include a bus 21 to connect components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, an I/O controller 28, a fixed storage 23 such as a hard drive, SSD drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone or other communication link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 6.

Many other devices or components (not shown) may be connected in a similar manner (e.g., document scanners, digital cameras and so on). Conversely, all of the components shown in FIG. 5 need not be present to practice the present disclosure. The components can be interconnected in different ways from those shown. The operation of a computer such as that shown in FIG. 5 is readily known in the art and is not discussed in detail in this application. Code to implement the present disclosure can be stored in computer-readable storage media such as one or more of the memory 27, fixed storage 23, removable media 25, or on a remote storage location.

FIG. 6 shows an example system suitable for use with the disclosed systems and methods. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, embodiments may include or be embodied in the form of computer-implemented methods and systems for practicing those methods. Embodiments also may be embodied in the form of a computer program product having computer program code containing instructions embodied in tangible media, such as floppy diskettes, CD-ROMs, DVD-ROMs, Blu-Ray discs, hard drives, USB (universal serial bus) drives, or any other machine readable storage medium, where, when the computer program code is loaded into and executed by a computer, the computer becomes an apparatus for practicing the invention. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the method in accordance with the present invention in hardware and/or firmware. The processor may be coupled to memory, such as RAM, ROM, flash memory, a hard disk or any other device capable of storing electronic information. The memory may store instructions adapted to be executed by the processor to perform the method in accordance with an embodiment of the present invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A method comprising:
obtaining a plurality of versions of a plurality of segments of a song, each segment being defined within the song by one or more breakpoints;
receiving a selection of a version of each of the plurality of segments of the song from a user;
subsequent to receiving the selection of the versions of the plurality of segments from the user, generating a version of the song comprising each selected version of each of the plurality of segments of the song; and
providing the generated version of the song to the user based upon the received selections, the generated version of the song including each selected version of each of the plurality of segments.

2. The method of claim 1, wherein the plurality of versions of the plurality of segments are received from an artist of the song.

3. The method of claim 1, further comprising storing each of the plurality of versions of the song in a computer-readable storage medium.

4-6. (canceled)

7. The method of claim 1, further comprising providing additional media content to the user with the generated version of the song.

8. The method of claim 7, wherein the additional media content comprises at least one item selected from the group consisting of: liner notes, an image, and artist commentary.

9. The method of claim 1, further comprising providing a user interface illustrating assembly of the generated song.

10. (canceled)

11. A system comprising:
one or more databases storing a plurality of versions of a plurality of segments of a song, each segment being defined within the song by one or more breakpoints;
a computerized system configured to:
receive a selection of a version of each of the plurality of segments of the song from a user;
subsequent to receiving the selection of the versions of the plurality of segments from the user, generate a version of the song comprising each selected version of each of the plurality of segments of the song; and
provide a generated version of the song to the user based upon the received selections, the generated version of the song including each selected version of each of the plurality of segments.

12. The system of claim 11, wherein the plurality of versions of the plurality of segments are received from an artist of the song.

13. The system of claim 11, further comprising storing each of the plurality of versions of the song in the one or more databases.

14-16. (canceled)

17. The system of claim 11, said computerized system further configured to provide additional media content to the user with the generated version of the song.

18. The system of claim 17, wherein the additional media content comprises at least one item selected from the group consisting of: liner notes, an image, and artist commentary.

19. The system of claim 11, said computerized system further configured to provide a user interface illustrating assembly of the generated song.

20. The system of claim 11, said computerized system further configured to receive an indication of a plurality of versions of the song that are available to the user.

21. The method of claim 1, wherein each of the one or more breakpoints is defined by an artist of the song.

22. The system of claim 11, wherein each of the one or more breakpoints is defined by an artist of the song.
